(19) United States
(12) Patent Application Publication
(10) Pub. No.: US 2013/0296393 A1
(43) Pub. Date: Nov. 7, 2013

(54) METHOD FOR CONTROLLING CLUBROOT

(71) Applicants: Hiroyuki Hayashi, Shiga (JP); Masanari Ohno, Shiga (JP)

(72) Inventors: Hiroyuki Hayashi, Shiga (JP); Masanari Ohno, Shiga (JP)

(73) Assignee: ISHIHARA SANGYO KAISHA, LTD., Osaka-shi, Osaka (JP)

(21) Appl. No.: 13/978,666

(22) PCT Filed: Jan. 11, 2012
(86) PCT No.: PCT/JP2012/051004

§ 371 Date: Jul. 30, 2013

(30) Foreign Application Priority Data
Jan. 11, 2011 (JP) 2011-002691

(51) Int. Cl. A01N 43/50

(52) U.S. Cl. CPC A01N 43/50
USPC 514/398

(57) ABSTRACT

In order to control the clubroot of brassica vegetables which is settled-planted in a farm field, it is necessary to previously treat the seedling with a chemical before settled planting or treat the soil with a chemical, but the clubroot is sometimes not controlled depending on the weather or soil conditions. In addition, the treatment with a fungicidal compound at a high concentration causes a problem of phytotoxicity or crop persistence. An object of the present invention is to solve these problems and provide a method for easily and simply controlling clubroot without causing a problem of phytotoxicity or crop persistence. The present invention provides a method for controlling clubroot, comprising applying cyazofamid to brassica vegetables after seeding or settled planting in a farm field.

### TECHNICAL FIELD

The present invention relates to a method for controlling clubroot, comprising applying cyazofamid to brassica vegetables after seeding or settled planting in a farm field.

### BACKGROUND ART

Clubroot is an infectious soil born disease caused by Plasmodiophora brassicae which is a kind of mold. The target for clubroot control includes brassica vegetables. Conventionally, the clubroot of brassica vegetables has been controlled by applying a soil incorporation treatment with a fungicide for clubroot control to a farm field before settled planting of seedlings of brassica vegetables. However, in a season having a lot of rainfall, such as rainy season, even when the farm field is treated by soil incorporation of a fungicide for clubroot control, sometimes the clubroot may not be controlled due to ununiformity of incorporation and there is a problem that the treatment is susceptible to weather or soil conditions.

On the other hand, a method of controlling the clubroot by treating brassica vegetables after settled planting in a farm field with a fungicidal compound has been heretofore conceptually known. However this method has not been put into practice. Since it is necessary to treat the fungicidal compound at a high concentration, not only it is economically disadvantageous, but also it causes a problem of phytotoxicity or crop persistence due to the fungicidal compound. Accordingly, as in Patent Literature 1, a seedling raising method which comprises subjecting roots of the seedling of a brassica crop before settled planting to a drench treatment or soaking treatment with a wettable powder or flowable formulation of a clubroot control agent such as flusulfamide, thereby forming a coating of the clubroot control agent on the root surface, has been proposed. Also, as in Patent Literature 2, a method of applying a plant base treatment with a sulfamoyl compound to control the clubroot of brassica vegetables has been proposed. In this method, it is said that the chemical treatment is preferably applied before and after 20 days around the seeding or settled planting of brassica vegetables, but the method for applying the treatment with the fungicidal compound after settled planting of brassica vegetables is not specifically described. Furthermore, in Patent Literatures 3 and 4, a method for controlling the clubroot by using a fungicidal compound such as cyazofamid is described, but this method differs from the method of the present invention in that cyazofamid is not applied to brassica vegetables after settled planting in a farm field.

### CITATION LIST

### Patent Literature

Patent Literature 1 JP-A-H8-71

Patent Literature 2 JP-A-2005-82479

Patent Literature 3 JP-A-2007-308375

Patent Literature 4 JP-A-2008-189658

### SUMMARY OF INVENTION

### Technical Problem

An object of the present invention is to find a clubroot control method using a fungicidal compound which can be applied at a practical concentration where the problem of phytotoxicity or crop persistence due to the treatment of a fungicidal compound at a high-concentration does not arise.

### Solution to Problem

As a result of intensive studies to attain the object above, the present inventors have found that when cyazofamid is applied to brassica vegetables after settled planting in a farm field, the clubroot can be controlled and furthermore phytotoxicity is not caused. The present invention has been accomplished based on this finding. That is, the present invention relates to a method for controlling clubroot by applying cyazofamid to brassica vegetables after seeding or settled planting in a farm field (hereinafter also referred to as the method of the present invention).

### Advantageous Effects of Invention

The present invention can provide a method which can effectively control the clubroot of brassica vegetables even by a chemical treatment after seeding or settled planting in a farm field which has been heretofore considered to be difficult to put into practical use in view of the problem of phytotoxicity or the like.

In addition, since the present invention can provide a method which exhibits a practical effect even in a farm field which is difficult to be subjected to an incorporation treatment with a dust formulation due to the effect of weather or soil conditions such as ill-drained soil, it is possible to efficiently control the clubroot by a simple and easy method.

### DESCRIPTION OF EMBODIMENTS

Cyazofamid is a common name, and its chemical name is 4-chloro-2-cyano-1-dimethylsulfamoyl-5-(4-methylphenyl)imidazole. The cyazofamid is a compound having a control activity against clubroot.

The cyazofamid as an active ingredient compound can be formulated in various forms such as an emulsifiable concentrate, a dust formulation, a wettable powder, a liquid formulation, a granule and a suspension concentrate by blending various adjuvants according to the conventional process for making an agricultural chemical formulation. At this time, cyazofamid and the above adjuvants may be mixed and formulated together or may be separately formulated and then mixed. The adjuvant as used herein includes a carrier, an emulsifying agent, a suspending agent, a thickening agent, a stabilizing agent, a dispersing agent, a spreading agent, a wetting agent, a penetrating agent, an antifreezing agent, an antifoaming agent and the like, and these may be appropriately added, if necessary. Among the formulation forms described above, a suspension concentrate such as Ranman (trade name) flowable (manufactured by Ishihara Sangyo Kaisha Ltd.) and Docious (trade name) flowable (manufactured by Ishihara Sangyo Kaisha Ltd.) is preferably used.

The above carrier is classified into a solid carrier and a liquid carrier, and examples of the solid carrier include animal and plant powders such as starch, sugar, cellulose powder, cyclodextrin, activated carbon, soybean powder, wheat powder, rice husk powder, wood powder, fish powder, and milk powder; mineral powders such as talc, kaolin, bentonite, organic bentonite, calcium carbonate, calcium sulfate, sodium bicarbonate, zeolite, diatomaceous earth, white carbon, clay, alumina, silica, sulfur powder, and slaked lime; and the like. Examples of the liquid carrier include water; plant oils such as soybean oil and cotton seed oil; animal oils such as beef tallow and whale oil; alcohols such as ethyl alcohol and ethylene glycol; ketones such as acetone, methyl ethyl ketone, methyl isobutyl ketone, and isophorone; ethers such as dioxane and tetrahydrofuran; aliphatic hydrocarbons such as kerosene, lamp oil, liquid paraffin, and cyclohexane; aromatic hydrocarbons such as toluene, xylene, trimethylbenzene, tetramethylbenzene, and solvent naphtha; halogenated hydrocarbons such as chloroform and chlorobenzene; acid amides such as N,N-dimethylformamide; esters such as ethyl acetate ester and fatty acid glycerol ester; nitriles such as acetonitrile; sulfur-containing compounds such as dimethyl sulfoxide; N-methyl-2-pyrrolidone; and the like.

As the emulsifying agent, various emulsifying agents are used, and examples thereof include nonionic surfactants and anionic surfactants capable of functioning as an emulsifying agent, and the like.

Examples of the suspending agent include Veegum R (trade name, manufactured by Sanyo Chemical Industries, Ltd.), and the like.

Examples of the thickening agent include inorganic particles such as carbonates, silicates, oxides; organic substances such as urea-formaldehyde condensates; and the like.

Examples of the stabilizing agent include epoxidized animal and plant oils, nonionic polyoxyethylene surfactants, anionic polyoxyethylene surfactants, polyhydric alcohols, basic substances, and the like.

Examples of the dispersing agent include anionic surfactants such as naphthalene sulfonate salts, naphthalene sulfonate-formalin condensate salts, alkyl naphthalene sulfonate salts, alkyl naphthalene sulfonate-formalin condensate salts, phenol sulfonate salts, phenol sulfonate-formalin condensate salts, lignin sulfonate salts, polycarboxylate salts, polyoxyethylene alkyl ether sulfate ester salts, polyoxyethylene alkyl aryl ether sulfate salts, polyoxyethylene alkyl ether sulfate ester salts, polyoxyethylene alkyl ether phosphate salts, and polyoxyethylene alkyl aryl ether phosphate ester salts; nonionic surfactants such as oxyalkylene block polymers, polyoxyethylene alkyl ethers, polyoxyethylene alkyl aryl ethers, polyoxyethylene styryl aryl ethers, polyoxyethylene glycol alkyl ethers, polyoxyethylene hydrogenated castor oil, and polyoxyethylene castor oil; and the like.

Examples of the spreading agent include sodium alkyl sulfates, sodium alkylbenzene sulfonates, sodium lignin sulfonates, polyoxyethylene glycol alkyl ethers, polyoxyethylene lauryl ethers, polyoxyethylene alkyl aryl ethers, polyoxyethylene sorbitan fatty acid esters, and the like.

Examples of the wetting agent include cationic, anionic, amphoteric, and nonionic surfactants and the like as well known in this technical field.

Examples of the penetrating agent include fatty alcohol alkoxylates, mineral oils, plant oils, esters of mineral oils or plant oils, and the like.

Examples of the antifreezing agent include ethylene glycol, propylene glycol, and the like.

Examples of the antifoaming agent include Rhodorsil 432 (trade name, manufactured by Rhodia Nicca Ltd.), Anti-mousse (trade name, manufactured by BELCHIM CROP PROTECTION), and the like.

The ratio of cyazofamid in the formulation containing cyazofamid as an active ingredient compound is usually 0.1 to 70 wt %, preferably 0.1 to 20 wt %, more preferably 0.1 to 10 wt %, based on the entire weight of the formulated product. When the formulation product is used in actual, the formulated product may be used as it is or may be used after diluting it with a diluent such as water to a predetermined concentration.

The cyazofamid as an active ingredient compound has a high control effect on clubroot of brassica vegetables and also exhibits an excellent control effect on downy mildew, white rust or late blight of brassica vegetables or on various soil diseases caused by plant pathogens such as Pythium. The method of the present invention enables simultaneous control of the diseases other than clubroot, and also the method of the present invention is an effective control method on this point.

The cyazofamid that is an active ingredient compound may be used as a mixture or in combination with, for example, other agricultural chemicals, a fertilizer or an agent for reducing phytotoxicity, and in this case, the compound sometimes exhibits more excellent effects and actions. Examples of other agricultural chemicals include a herbicide, a fungicide, an insecticide, a miticide, a nematicide, and a soil insecticide. In addition, even if not specifically indicated, when there is such a salt and an alkyl ester of these agricultural chemicals, these are naturally included in the other agricultural chemicals.

Examples of the active ingredient of the herbicide include the following compounds (common names, including some which are under application for ISO).
(1) Those believed to exhibit a herbicidal effect by disturbing hormone activities of plants, including phenoxy compounds such as 2,4-D, 2,4-D-butotyl, 2,4-D-butyl, 2,4-D-dimethylammonimum, 2,4-D-diolamine, 2,4-D-ethyl, 2,4-D-2-ethylhexyl, 2,4-D-isobutyl, 2,4-D-isoctyl, 2,4-D-isopropyl, 2,4-D-isopropylammonium, 2,4-D-sodium, 2,4-D-isopropanolammonium, 2,4-D-trolamine, 2,4-DB, 2,4-DB-butyl, 2,4-DB-dimethylammonium, 2,4-DB-isoctyl, 2,4-DB-potassium, 2,4-DB-sodium, dichlorprop, dichlorprop-butotyl, dichlorprop-dimethylammonium, dichlorprop-isoctyl, dichlorprop-potassium, dichlorprop-P, dichlorprop-P-dimethyl ammonium, dichlorprop-P-potassium, dichlorprop-P-sodium, MCPA, MCPA-butotyl, MCPA-dimethylammonium, MCPA-2-ethylhexyl, MCPA-potassium, MCPA-sodium, MCPA-thioethyl, MCPB, MCPB-ethyl, MCPB-sodium, mecoprop, mecoprop-butotyl, mecoprop-sodium, mecoprop-P, mecoprop-P-butotyl, mecoprop-P-dimethylammonium, mecoprop-P-2-ethylhexyl, mecoprop-P-potassium, naproanilide, and clomeprop; aromatic carboxylic acid compounds such as 2,3,6-TBA, dicamba, dicamba-butotyl, dicamba-diglycolamine, dicamba-dimethylammonium, dicamba-diolamine, dicamba-isopropylammonium, dicamba-potassium, dicamba-sodium, dichlobenil, picloram, picloram-dimethylammonium, picloram-isoctyl, picloram-potassium, picloram-triisopropanolammonium, picloram-triisopropylammonium, picloram-trolamine, triclopyr, triclopyr-butotyl, triclopyr-triethylammonium, clopyralid, clopyralid-olamine, clopyralid-potassium, clopyralid-triisopropanolammonium, and aminopyralid; and others, for example, naptalam, naptalam-sodium, benazolin, benazolin-ethyl, quinclorac, quinmerac, diflufenzopyr, diflufenzopyr-sodium, fluoroxypyr, fluoroxypyr-2-butoxy-1-methylethyl, fluoroxypyr-meptyl, chlorflurenol, and chlorflurenol-methyl.
(2) Those believed to exhibit a herbicidal effect by inhibiting photosynthesis of plants, including urea compounds such as chlorotoluron, diuron, fluometuron, linuron, isoproturon, metobenzuron, tebuthiuron, dimefuron, isouron, karbutilate, methabenzthiazuron, metoxuron, monolinuron, neburon, siduron, terbumeton, and trietazine; triazine compounds such as simazine, atrazine, atratone, simetryn, prometryn, dimethametryn, hexazinone, metribuzin, terbuthylazine, cyanazine, ametryn, cybutryne, triaziflam, terbutryn, propazine, metamitron, prometon, and indaziflam; uracil compounds such as bromacil, bromacyl-lithium, lenacil, and terbacil; anilide compounds such as propanil and cypromid; carbamate compounds such as swep, desmedipham, and phenmedipham; hydroxybenzonitrile compounds such as bromoxynil, bromoxynil-octanoate, bromoxynil-heptanoate, ioxynil, ioxynil-octanoate, ioxynil-potassium, and ioxynil-sodium; and others, for example, pyridate, bentazone, bentazone-sodium, amicarbazone, methazole and pentanochior.
(3) Those believed to convert to a free radical by itself in the plant body to generate active oxygen, thereby exhibiting a rapid herbicidal effect, including quaternary ammonium salt compounds such as paraquat and diquat.
(4) Those believed to exhibit a herbicidal effect by inhibiting chlorophyll biosynthesis of plants and abnormally accumulating a photosensitizing peroxide substance in the plant body, including diphenylether compounds such as nitrofen, chlomethoxyfen, bifenox, acifluorfen, acifluorfen-sodium, fomesafen, fomesafen-sodium, oxyfluorfen, lactofen, aclonifen, ethoxyfen-ethyl (HC-252), fluoroglycofen-ethyl, and fluoroglycofen; cyclic imide compounds such as chlorphthalim, flumioxazin, flumiclorac, flumiclorac-pentyl, cinidon-ethyl, and fluthiacet-methyl; and others, for example, oxadiargyl, oxadiazon, sulfentrazone, carfentrazone-ethyl, thidiazimin, pentoxazone, azafenidin, isopropazole, pyraflufen-ethyl, benzfendizone, butafenacil, saflufenacil, flupoxam, fluazolate, profluazol, pyraclonil, flufenpyr-ethyl, and bencarbazone.
(5) Those believed to exhibit a herbicidal effect characterized by bleaching activities by inhibiting chromogenesis of plants such as carotenoids, including pyridazinone compounds such as norflurazon, chloridazon, and metflurazon; pyrazole compounds such as pyrazolynate, pyrazoxyfen, benzofenap, topramezone (BAS-670H), and pyrasulfotole; and others, for example, amitrole, fluridone, flurtamone, diflufenican, methoxyphenone, clomazone, sulcotrione, mesotrione, tembotrione, tefuryltrione (AVH-301), isoxaflutole, difenzoquat, difenzoquat-metilsulfate, isoxachlortole, benzobicyclon, picolinafen, and beflubutamid.
(6) Those exhibiting a strong herbicidal effect specifically to gramineous plants, including aryloxyphenoxypropionic acid compounds such as diclofop-methyl, diclofop, pyriphenop-sodium, fluazifop-butyl, fluazifop, fluazifop-P, fluazifop-P-butyl, haloxyfop-methyl, haloxyfop, haloxyfop-etotyl, haloxyfop-P, haloxyfop-P-methyl, quizalofop-ethyl, quizalofop-P, quizalofop-P-ethyl, quizalofop-P-tefuryl, cyhalofop-butyl, fenoxaprop-ethyl, fenoxaprop-P, fenoxaprop-P-ethyl, metamifop-propyl, metamifop, clodinafop-propargyl, clodinafop, and propaquizafop; cyclohexanedione compounds such as alloxydim-sodium, alloxydim, clethodim, sethoxydim, tralkoxydim, butroxydim, tepraloxydim, profoxydim, and cycloxydim; and others, for example, flamprop-M-methyl, flamprop-M and flamprop-M-isopropyl.
(7) Those believed to exhibit a herbicidal effect by inhibiting an amino acid biosynthesis of plants, including sulfonylurea compounds such as chlorimuron-ethyl, chlorimuron, sulfometuron-methyl, sulfometuron, primisulfuron-methyl, primisulfuron, bensulfuron-methyl, bensulfuron, chlorsulfuron, metsulfuron-methyl, metsulfuron, cinosulfuron, pyrazosulfuron-ethyl, pyrazosulfuron, azimsulfuron, flazasulfuron, rimsulfuron, nicosulfuron, imazosulfuron, cyclosulfamuron, prosulfuron, flupyrsulfuron-methyl-sodium, flupyrsulfuron, triflusulfuron-methyl, triflusulfuron, halosulfuron-methyl, halosulfuron, thifensulfuron-methyl, thifensulfuron, ethoxysulfuron, oxasulfuron, ethametsulfuron, ethametsulfuron-methyl, iodosulfuron, iodosulfuron-methyl-sodium, sulfosulfuron, triasulfuron, tribenuron-methyl, tribenuron, tritosulfuron, foramsulfuron, trifloxysulfuron, trifloxysulfuron-sodium, mesosulfuron-methyl, mesosulfuron, orthosulfamuron, flucetosulfuron, amidosulfuron, propyrisulfuron (TH-547), NC-620, and compounds disclosed in WO 2005/092104; triazolopyrimidinesulfonamide compounds such as flumetsulam, metosulam, diclosulam, cloransulam-methyl, florasulam, penoxsulam, and pyroxsulam; imidazolinone compounds such as imazapyr, imazapyr-isopropylammonium, imazethapyr, imazethapyr-ammonium, imazaquin, imazaquin-ammonium, imazamox, imazamox-ammonium, imazamethabenz, imazamethabenz-methyl, and imazapic; pyrimidinylsalicylic acid compounds such as pyrithiobac-sodium, bispyribac-sodium, pyriminobac-methyl, pyribenzoxim, pyriftalid, and pyrimisulfan (KUH-021); sulfonylaminocarbonyltriazolinone compounds such as flucarbazone, flucarbazone-sodium, propoxycarbazone-sodium, and propoxycarbazone; and others, for example, glyphosate, glyphosate-sodium, glyphosate-potassium, glyphosate-ammonium, glyphosate-diammonium, glyphosate-isopropylammonium, glyphosate-trimesium, glyphosate-sesquisodium, glufosinate, glufosinate-ammonium, glufosinate-P, glufosinate-P-ammonium, glufosinate-P-sodium, bilanafos, bilanafos-sodium, and cinmethylin.
(8) Those believed to exhibit a herbicidal effect by inhibiting cell mitoses of plants, including dinitroaniline compounds such as trifluralin, oryzalin, nitralin, pendimethalin, ethalfluralin, benfluralin, prodiamine, butralin, and dinitramine; amide compounds such as bensulide, napropamide, propyzamide, and pronamide; organic phosphorus compounds such as amiprofos-methyl, butamifos, anilofos, and piperophos; phenyl carbamate compounds such as propham, chlorpropham, barban, and carbetamide; cumylamine compounds such as daimuron, cumyluron, bromobutide, and methyldymron; and others, for example, asulam, asulam-sodium, dithiopyr, thiazopyr, chlorthal-dimethyl, chlorthal, and diphenamid.
(9) Those believed to exhibit a herbicidal effect by inhibiting protein biosynthesis or lipid biosynthesis of plants, including chloroacetamide compounds such as alachlor, metazachlor, butachlor, pretilachlor, metolachlor, S-metolachlor, thenylchlor, pethoxamid, acetochlor, propachlor, dimethenamid, dimethenamid-P, propisochloror, and dimethachlor; thiocarbamate compounds such as molinate, dimepiperate, pyributicarb, EPTC, butylate, vernolate, pebulate, cycloate, prosulfocarb, esprocarb, thiobencarb, diallate, tri-allate, and orbencarb; and others, for example, etobenzanid, mefenacet, flufenacet, tridiphane, cafenstrole, fentrazamide, oxaziclomefone, indanofan, benfuresate, pyroxasulfone (KIH-485), dalapon, dalapon-sodium, TCA-sodium, and trichloroacetic acid.
(10) Those believed to exhibit a herbicidal effect by being parasitic on plants, including Xanthomonas campestris, Epicoccosirus nematosorus, Epicoccosirus nematosperus, Exserohilum monoseras, and Drechsrela monoceras.
(11) Those believed to exhibit a herbicidal effect and not listed in (1) to (10), including MSMA, DSMA, CMA, endothall, endothall-dipotassium, endothall-sodium, endothall-mono(N,N-dimethylalkylammonium), ethofumesate, sodium chlorate, pelargonic acid, nonanoic acid, fosamine, fosamine-ammonium, pinoxaden, ipfencarbazone (HOK-201), aclolein, ammonium sulfamate, borax, chloroacetic acid, sodium chloroacete, cyanamide, methylarsonic acid, dimethylarsinic acid, sodium dimethylarsinate, dinoterb, dinoterb-ammonium, dinoterb-diolamine, dinoterb-acetate, DNOC, ferrous sulfate, flupropanate, flupropanate-sodium, isoxaben, mefluidide, mefluidide-diolamine, metam, metam-ammonium, metam-potassium, metam-sodium, methyl isothiocyanate, pentachlorophenol, sodium pentachlorophenoxide, pentachlorophenol laurate, quinoclamine, sulfuric acid, urea sulfate, and the like.

Examples of the active ingredient compound in the above fungicide (common names, including some which are under application or the test code of the Japan Plant Protection Association) of the fungicide include anilinopyrimidine compounds such as mepanipyrim, pyrimethanil, and cyprodinil; triazolopyrimidine compounds such as 5-chloro-7-(4-methylpiperidin-1-yl)-6-(2,4,6-trifluorophenyl)[1,2,4]triazolo[1,5-a]pyrimidine; pyrimidinamine compounds such as fluazinam; azole compounds such as triadimefon, bitertanol, triflumizole, etaconazole, propiconazole, penconazole, flusilazole, myclobutanil, cyproconazole, tebuconazole, hexaconazole, furconazole-cis, prochloraz, metconazole, epoxiconazole, tetraconazole, oxpoconazole fumarate, sip conazole, prothioconazole, triadimenol, flutriafol, difenoconazole, fluquinconazole, fenbuconazole, bromuconazole, diniconazole, tricyclazole, probenazole, simeconazole, pefurazoate, ipconazole, and imibenconazole; quinoxaline compounds such as quinomethionate; dithiocarbamate compounds such as maneb, zineb, mancozeb, polycarbamate, metiram, propineb, and thiram; organic chlorine compounds such as fthalide, chlorothalonil and quintozene; imidazole compounds such as benomyl, thiophanate-methyl, carbendazim, thiabendazole, and fuberiazole; cyano acetamide compounds such as cymoxanil; anilide compounds such as metalaxyl, metalaxyl-M, mefenoxam, oxadixyl, ofurace, benalaxyl, benalaxyl-M (another name; kiralaxyl or chiralaxyl), furalaxyl, cyprofuram, carboxin, oxycarboxin, thifluzamide, boscalid, isothianil, bixafen, tiadinil, and sedaxane; sulfamid compounds such as dichlofluanid; copper compounds such as cupric hydroxide and oxine copper; an isoxazole compound such as hymexazol; organic phosphorus compounds such as fosetyl-Al, tolclofos-methyl, S-benzyl O,O-diisopropylphosphorothioate, O-ethyl S,S-diphenylphosphorodithioate, aluminum ethylhydrogen phosphonate, edifenphos, and iprobenfos; phthalimide compounds such as captan, captafol, and folpet; dicarboxyimide compounds such as procymidone, iprodione, and vinclozolin; benzanilide compounds such as flutolanil, and mepronil; amide compounds such as penthiopyrad, a mixture of 3-(difluoromethyl)-1-methyl-N-[(1RS,4SR,9RS)-1,2,3,4-tetrahydro-9-isopropyl-1,4-methanonaphthalen-5-yl]pyrazole-4-carboxamide and 3-(difluoromethyl)-1-methyl-N-[(1RS,4SR,9SR)-1,2,3,4-tetrahydro-9-isopropyl-1,4-methanonaphthalen-5-yl]pyrazole-4-carboxamide (isopyrazam), silthiopham, and fenoxanil; piperazine compounds such as triforine; pyridine compounds such as pyrifenox; carbinol compounds such as fenarimol; piperidine compounds such as fenpropidine; morpholine compounds such as fenpropimorph, spiroxamine, and tridemorph; organotin compounds such as fentin hydroxide and fentin acetate; urea compounds such as pencycuron; cinnamic acid compounds such as dimethomorph and flumorph; phenylcarbamate compounds such as diethofencarb; cyanopyrrole compounds such as fludioxonil and fenpiclonil; strobilurin compounds such as azoxystrobin, kresoxim-methyl, metominostrobin, trifloxystrobin, picoxystrobin, oryzastrobin, dimoxystrobin, pyraclostrobin, and fluoxastrobin; oxazolidinone compounds such as famoxadone; thiazolecarboxamide compounds such as ethaboxam; silylamide compounds such as silthiopham; valine amide compounds such as iprovalicarb, and benthiavalicarb-isopropyl; imidazolinone compounds such as fenamidone; hydroxyanilide compounds such as fenhexamid; benzenesulfonamide compounds such as flusulfamide; oxime ether compounds such as cyflufenamid; phenoxyamide compounds such as fenoxanil; anthraquinone compounds; crotonic acid compounds; antibiotic such as validamycin, kasugamycin, and polyoxins; guanidine compounds such as iminoctadine and dodine; quinolin compounds such as 6-t-butyl-8-fluoro-2,3-dimethylquinolin-4-ylacetate(tebufloquin); thiazolidine compounds such as (Z) 2-(2-fluoro-5-(trifluromethyl)phenylthio)-2-(3-(2-methoxyphenyl)thiazolidin-2-yliden)acetonitrile (flutianil); other compounds such as pyribencarb, isoprothiolane, pyroquilon, diclomezine, quinoxyfen, propamocarb hydrochloride, chloropicrin, dazomet, metam-sodium, nicobiferi, metrafenone, UBF-307, diclocymet, proquinazid, amisulbrom (another name: amibromdole), pyriofenone, mandipropamid, fluopicolide, carpropamid, meptyldinocap, ferimzone, spiroxamine, S-2188 (fenpyrazamine), S-2200, ZF-9646, BCF-051, BCM-061, and BCM-062; and the like.

Examples of the active ingredient compound of the above insecticide, the above miticide, the above nematicide or the above soil insecticide (common names, including some which are under application or the test code of the Japan Plant Protection Association) of the insecticide, miticide, nematicide, or soil insecticide include organic phosphate ester compounds such as profenofos, dichlorvos, fenamiphos, fenitrothion, EPN, diazinon, chlorpyrifos, chlorpyrifos-methyl, acephate, prothiofos, fosthiazate, cadusafos, disulfoton, isoxathion, isofenphos, ethion, etrimfos, quinalphos, dimethylvinphos, dimethoate, sulprofos, thiometon, vamidothion, pyraclofos, pyridaphenthion, pirimiphos-methyl, propaphos, phosalone, formothion, malathion, tetrachlovinphos, chlorfenvinphos, cyanophos, trichlorfon, methidathion, phenthoate, ESP, azinphos-methyl, fenthion, heptenophos, methoxychlor, parathion, phosphocarb, demeton-S-methyl, monocrotophos, methamidophos, imicyafos, parathion-methyl, terbufos, phosphamidon, phosmet, and phorate; carbamate compounds such as carbaryl, propoxur, aldicarb, carbofuran, thiodicarb, methomyl, oxamyl, ethiofencarb, pirimicarb, fenobucarb, carbosulfan, benfuracarb, bendiocarb, furathiocarb, isoprocarb, metolcarb, xylylcarb, XMC, and fenothiocarb; nereistoxin derivatives such as cartap, thiocyclam, bensultap, and thiosultap-sodium; organic chlorine compounds such as dicofol, tetradifon, endosulufan, dienochlor, and dieldrin; organic metal compounds such as fenbutatin oxide and cyhexatin; pyrethroid compounds such as fenvalerate, permethrin, cypermethrin, deltamethrin, cyhalothrin, tefluthrin, ethofenprox, flufenprox, cyfluthrin, fenpropathrin, flucythrinate, fluvalinate, cycloprothrin, lambda-cyhalothrin, pyrethrins, esfenvalerate, tetramethrin, resmethrin, protrifenbute, bifenthrin, zeta-cypermethrin, acrinathrin, alpha-cypermethrin, allethrin, gamma-cyhalothrin, theta-cypermethrin, tau-fluvalinate, tralomethrin, profluthrin, beta-cypermethrin, beta-cyfluthrin, metofluthrin, phenothrin, imidate, and flumethrin; benzoylurea compounds such as diflubenzuron, chlorfluazuron, teflubenzuron, flufenoxuron, lufenuron, novaluron, triflumuron, hexaflumuron, bistrifluron, noviflumuron, and fluazuron; juvenile hormone-like compounds such as methoprene, pyriproxyfen, fenoxycarb, and diofenolan; pyridazinone compounds such as pridaben; pyrazole compounds such as fenpyroximate, fipronil, tebufenpyrad, ethiprole, tolfenpyrad, acetoprole, pyrafluprole, and pyriprole; neonicotinoids such as imidacloprid, nitenpyram, acetamiprid, thiacloprid, thiamethoxam, clothianidin, nidinotefuran, dinotefuran, and nithiazine; hydrazine compounds such as tebufenozide, methoxyfenozide, chromafenozide, and halofenozide; pyridine compounds such as pyridalyl and flonicamid; cyclic keto-enol compounds such as spirodiclofen, spiromesifen, and spirotetramat; strobilurin compounds such as fluacrypyrim; pyrimidinamine compounds such as flufenerim; dinitro compounds; organic sulfur compounds; urea compounds; triazine compounds; hydrazone compounds; and other compounds, for example, buprofezin, hexythiazox, amitraz, chlordimeform, silafluofen, triazamate, pymetrozine, pyrimidifen, chlorfenapyr, indoxacarb, acequinocyl, etoxazole, cyromazine, 1,3-dichloropropene, diafenthiuron, benclothiaz, bifenazate, propargite, clofentezine, metaflumizone, flubendiamide, cyflumetofen, chlorantraniliprole, cyenopyrafen, pyrifluquinazon, fenazaquin, amidoflumet, sulfluramid, hydramethylnon, metaldehyde, cyantraniliprole, ryanodine, verbutin, and the like. Further, microbial agricultural chemicals such as crystalline protein toxins manufactured by Bacillus thuringiensis aizawai, Bacillus thuringiensis kurstaki, Bacillus thuringiensis israelensis, Bacillus thuringiensis japonensis, Bacillus thuringiensis tenebrionis, or Bacillus thuringiensis; entomopathogenic viral agents, entomopathogenic fungal agents, and nematopathogenic fungal agents; antibiotic and semisynthetic antibiotic such as avermectin, emamectin Benzoate, milbemectin, milbemycin, spinosad, ivermectin, lepimectin, DE-175, abamectin, emamectin, and spinetoram; natural substances such as azadirachtin, and rotenone; repellents such as deet; and the like can be mentioned.

In addition, examples of the agricultural chemical which can be used as a mixture or in combination with cyazofamid include the active ingredient compounds of herbicides, particularly, a soil treatment type compound described in The Pesticide Manual (15th ed.). Examples of the fertilizer include a liquid fertilizer, a vitalizing agent, an activating agent and a foliar liquid fertilizer, and examples of the agent for reducing phytotoxicity include a calcium carbonate agent.

Each of the other agricultural chemicals, fertilizers, agents for reducing phytotoxicity, and the like may be used alone, or used in combination of two or more of them. In addition, cyazofamid and the component such as the other agricultural chemical, the fertilizer and the agent for reducing phytotoxicity may be separately formulated and mixed for use at the time of spraying, or both components may be formulated together and used.

The method for applying cyazofamid includes a general method utilized by one skilled in the art, such as foliar treatment and soil treatment (e.g., soil incorporation, soil drench). Among these, a soil treatment is preferred, soil incorporation or soil drench is more preferred, and soil drench is most preferred. The method of soil drench includes a method which comprises diluting a suspension concentrate of cyazofamid with water at 1 to 1,000 ppm, preferably 25 to 400 ppm, and applying the obtained solution at 1 to 1,000 ml, preferably 100 to 300 ml, per seedling after seeding or settled planting of brassica vegetables as a soil drench.

The term “after seeding or settled planting in a farm field” as used in the description of the present invention indicates the timing for the application of cyazofamid. Here, the timing for the application of cyazofamid is not particularly limited but is usually the growing period (from settled planting to harvest), preferably in 30 days after seeding or settled planting. Above all, from the standpoint of controlling clubroot of brassica vegetables in the stage of primary infection with Plasmodiophora brassicae, the timing is more preferably within 7 days after seeding or settled planting, and from the standpoint of obtaining a particularly high control effect, the timing is furthermore preferably within 4 days after seeding or settled planting.

As for the application of cyazofamid to soil, by using an appropriate apparatus such as a watering pot, a sprayer, a hand-operated granule applicator, an electric-powered granule applicator, or a powder applicator, for example, spraying, nebulizing, misting, atomizing, granule applying, or the like can be carried out.

Before and after the application of cyazofamid to soil, a common mulch-sheet for agricultural use such as a mulch-film, a functional mulch-film, a polyethylene film for agricultural use, or a biodegradable plastic mulch-film can be used.

In the clubroot control method of the present invention, cyazofamid is sprayed such that the amount of cyazofamid sprayed on the cultivation soil becomes 0.05 to 50 g/m², preferably 0.125 to 6 g/m². The amount sprayed on the cultivation soil can be appropriately changed depending on such as the form or application method of the formulation, the target plant for spraying, the timing or place of spraying, and the state of clubroot occurrence.

In the present invention, examples of the “farm field which is difficult to be subjected to an incorporation treatment with a dust formulation” includes a farm field where the soil contains a large amount of water due to the effect of weather before settled planting, and a farm field which is ill-drained due to the effect of secondary crop of paddy.

In the present invention, examples of the brassica vegetable as a target for clubroot control include turnip, Chinese cabbage, cabbage, broccoli, cauliflower, rape, Tenderstem broccoli, rapeseed, Japanese radish, kyona (Brassica campestris L.), komatsuna (Brassica rapa var.), takana (broad leaved mustard), mizuna (Brassica campestris L.), mibuna (Brassica rapa japonica), nozawana (Brassica rapa L.), mizukakena (Brassica campestris L.), kale, qing-geng-cai, small garden radish, Brussels sprout and wasabi.

Next, preferable embodiments of an agricultural or horticultural fungicide composition of the present invention are exemplified, but the present invention should not be construed that the invention is limited to these embodiments.
(1) A method for controlling clubroot, comprising applying cyazofamid to brassica vegetables after seeding or settled planting in a farm field.
(2) The method as described in (1), wherein cyazofamid is applied by a foliage application or a soil treatment.
(3) The method as described in (1), wherein cyazofamid is applied by a soil treatment.
(4) The method as described in (3), wherein cyazofamid is applied by a soil incorporation or a soil drench.
(5) The method as described in (3), wherein the soil treatment is a soil drench.
(6) The method as described in (1) or (5), wherein cyazofamid is applied in a farm field which is difficult to be subjected to an incorporation treatment with a dust formulation.
(7) The method as described in any one of (3) to (6), wherein the soil treatment comprises spraying cyazofamid to cultivation soil at 0.05 to 50 g/m².
(8) The method as described in (5), which comprises [1] diluting a suspension concentrate of cyazofamid with water at 1 to 1,000 ppm and then [2] treating the base of brassica vegetables after seeding or settled plantation by drenching the chemical solution obtained in [1] at 1 to 1,000 ml per plant.
(9) The method as described in any one of (1) to (8), wherein cyazofamid is applied to the brassica vegetable within 30 days after seeding or settled planting in the farm field.
(10) The method as described in any one of (1) to (8), wherein cyazofamid is applied to the brassica vegetable within 7 days after seeding or settled planting in the farm field.
(11) The method as described in any one of (1) to (8), wherein cyazofamid is applied to the brassica vegetable within 4 days after seeding or settled planting in the farm field.
(12) The method as described in any one of (1) to (11), wherein the brassica vegetable is at least one selected from the group consisting of turnip, Chinese cabbage, cabbage, broccoli, cauliflower, rape, Tenderstem broccoli, rapeseed, Japanese radish, kyona (Brassica campestris L.), komatsuna (Brassica rapa var.), takana (broad leaved mustard), mizuna (Brassica campestris L.), mibuna (Brassica rapa japonica), nozawana (Brassica rapa L.), mizukakena (Brassica campestris L.), kale, qing-geng-cai, small garden radish, Brussels sprout and wasabi.

### EXAMPLES

The present invention is described below by referring to Examples and Comparative Examples, but the present invention is not limited only to these Examples.

### Example 1

### Cabbage Clubroot Control Test

### (1) Preparation of Control Agent

A chemical solution for spraying at 50 ppm was prepared by diluting 9.4% w/w cyazofamid (Ranman [trade name] flowable, manufactured by Ishihara Sangyo Kaisha Ltd.) with water.

### (2) Test of Disease Control in Cabbage

A spore suspension of Plasmodiophora brassicae (fungus density: 1×10⁵ fungi/g dry soil) was inoculated into a sterilization soil adjusted to pH of 6.2 with Sandoseto and after introducing the resulting test soil into a 1/5000 a pot, a cabbage (variety: Okina) seedling grown in a cell seedling tray (128 cells/seedling box) was settled-planted by establishing five plantings for each test section having a size of 0.02 m² per one plant. Just after the settled planting, 3 days, 7 days, 10 days and 14 days after the settled planting, the chemical solution for spraying prepared in (1) was applied by soil drench at a ratio of 250 ml/plant. Sixty days after the settled planting, the number of each index of clubroot adhesion to the root was investigated. For comparison, the same test was carried out on a control section where a soil drench treatment with the chemical solution for spraying was not applied.

### Comparative Example 1

The test was carried out by the same method as in Example 1(2) except that in place of the soil drench treatment with the chemical solution for spraying, 30 kg/10 a of 0.3% flusulfamide (dust formulation of Nebijin [trade name], manufactured by Mitsui Chemicals Agro, Inc.) was applied to the test soil just before settled planting and incorporated into the soil by means of a small mixer (interfusion depth: 15 cm).

In Example 1 and Comparative Example 1, the adhesion of clubroot was investigated by pulling out the root of cabbage. The adhesion of clubroot was investigated by calculating the disease severity using the following formula. In addition, the weight of cabbage in the aerial part was measured. The test results were shown in Table 1. Furthermore, the test result was shown by the average value of five plantings.

Disease severity={Σ(number of each index of diseased plants×disease index)/(number of plants surveyed×4)}×100

Disease control value={1−(treatment disease severity/control disease severity)}×100

### Disease Index:

0: No adhesion of clubroot, 1: clubroot adhesion to lateral root, 2: clubroot adhesion to the entire lateral root or clubroot adhesion to a part of tap root, 3: adhesion of large clubroot to tap root, and 4: clubroot adhesion to the entire tap root.

TABLE 1

| | Timing of | Disease | Disease control | Weight in the |
|---|---|---|---|---|
| | treatment | severity | value | aerial part (g) |
| Example 1 | Just after | 15 | 81 | 164 |
| | settled planting | | | |
| | 3 days after | 20 | 75 | 156 |
| | 7 days after | 25 | 69 | 168 |
| | 10 days after | 40 | 50 | 164 |
| | 14 days after | 55 | 31 | 163 |
| Comparative | Just before | 0 | 100 | 173 |
| Example 1 | settled planting | | | |
| Control section | — | 80 | 0 | 137 |

As seen from the test results, it was found that the clubroot could be also controlled by this controlling method and in particular, when the treatment was applied within 7 days after settled planting, a control effect which was sufficient for practical use was obtained. Therefore, it was found that the clubroot could be controlled by a simple and easy method. In addition, the weight (g) in the aerial part is not so different from that in Comparative Example 1, and it was found that the effect of the disease was small and furthermore no phytotoxicity was caused.

### Example 2

### Cabbage Clubroot Control Test

A spore suspension of Plasmodiophora brassicae was sprayed on the entire farm field by using a watering pot to have a fungus density of 1×10⁴ fungi/g dry soil. In this farm field, a cabbage (variety: Okina) seedling grown in a cell seedling tray (128 cells/seedling box) was settled-planted by establishing two plantings for each test section containing ten plants (interplant distance: 30 cm, interrow space: 30 cm, planting in two rows). Just after the settled planting, 4 days, 7 days and 11 days after settled planting, the chemical solution for spraying prepared by the same method as in Example 1(1) was drenched into the soil in a ratio of 250 ml/plant. Seventy-seven days after the settled planting, the number of each index of clubroot adhesion to the root was investigated. For comparison, the same test was carried out on a control section where a soil drench treatment with the chemical solution for spraying was not applied.

### Comparative Example 2

The test was carried out by the same method as in Example 2 except that in place of the soil drench treatment with the chemical solution for spraying, a chemical solution for spraying prepared by the same method as in Example 1(1) was sprayed on a cabbage (variety: Okina) seedling grown in a cell seedling tray (128 cells/seedling box) at a concentration of 2 liters/cell seedling tray by using a watering pot and these seedlings were settled-planted.

The disease severity and disease control value of Example 2 and Comparative Example 2 were determined by the same methods as in Example 1 and Comparative Example 1. In addition, the weight of cabbage in the aerial part was measured. The test results were shown in Table 2. Furthermore, the test result was shown by the average value of two plantings.

TABLE 2

| | | | | Weight in |
|---|---|---|---|---|
| | Timing of | Disease | Disease control | the aerial |
| | treatment | severity | value | part (g) |
| Example 2 | Just after settled | 30 | 44 | 713 |
| | planting | | | |
| | 4 days after | 7 | 87 | 666 |
| | 7 days after | 38 | 30 | 579 |
| | 11 days after | 48 | 11 | 563 |
| Comparative | Just before settled | 30 | 44 | 745 |
| Example 2 | planting | | | |
| Control section | — | 54 | 0 | 444 |

As seen from the test results, it was found that clubroot could be also controlled by this controlling method and in particular, when the treatment was applied within 4 days after settled planting, a control effect equivalent to that in the case of spraying cyazofamid by a conventional control method was obtained. Therefore, it was found that the clubroot could be controlled by a simple and easy method. In addition, the weight (g) in the aerial part is not so different from that in Comparative Example 2, and it was found that the effect of the disease was small and furthermore no phytotoxicity was caused.

### Example 3

### Cabbage Clubroot Control Test

A spore suspension of Plasmodiophora brassicae (fungus density: 1×10⁵ fungi/g dry soil) was inoculated into a sterilization soil adjusted to pH of 6.0 with Sandoseto and after introducing the resulting test soil into a 1/5000 a pot, a cabbage (variety: Okina) seedling grown in a cell seedling tray (128 cells/seedling box) was settled-planted by establishing five plantings for each test section having a size of 0.02 m² for one plant. Immediately, 4 days, 7 days and 14 days after settled planting, the chemical solution for spraying prepared by the same method as in Example 1(1) was drenched into the soil in a ratio of 250 ml/plant. Fifty-seven days after the settled planting, the number of each index of clubroot adhesion to the root was investigated. For comparison, the same test was carried out on a control section where a soil drench treatment with the chemical solution for spraying was not applied.

### Comparative Example 3

### (1) Preparation of Control Agent

A chemical solution for spraying in a concentration of 800 ppm was prepared by diluting 40% chlorothalonil (Daconil 1000 [trade name], manufactured by SDS K.K.) with water.

### (2) Test of Disease Control in Cabbage

The test was carried out by the same procedure as in Example 3 except that the chemical solution (cyazofamid) for spraying was replaced by the chemical solution (chlorothalonil) for spraying prepared in Comparative Example 3(1).

The disease severity and disease control value of Example 3 and Comparative Example 3 were determined by the same methods as in Example 1 and Comparative Example 1. In addition, the weight of cabbage in the aerial part was measured. The test results were shown in Table 3. Furthermore, the test result was shown by the average value of five plantings.

TABLE 3

| | Timing of | Disease | Disease control | Weight in the |
|---|---|---|---|---|
| | treatment | severity | value | aerial part (g) |
| Example 3 | Just after settled | 0 | 100 | 104 |
| (cyazofamid) | planting | | | |
| | 4 days after | 15 | 81 | 109 |
| | 7 days after | 10 | 88 | 109 |
| | 14 days after | 80 | 0 | 91 |
| Comparative | Just after settled | 35 | 56 | 96 |
| Example 3 | planting | | | |
| (chlorothalonil) | 4 days after | 60 | 25 | 92 |
| | 7 days after | 90 | 0 | 69 |
| | 14 days after | 90 | 0 | 70 |
| Control Section | — | 80 | 0 | 81 |

As seen from the test results, in Example 3 (the case of using cyazofamid), a control effect which was sufficient for practical use was obtained by the treatment within 7 days after settled planting, but in Comparative Example 3 (the case of using chlorothalonil), a control effect which is sufficient for practical use was not obtained. It was also found that in Comparative Example 3, the weight (g) in the aerial part was greatly affected by the disease and the practical utility was low.

Here, as described in Background Art above, the clubroot of brassica vegetables has been conventionally controlled by applying a soil incorporation treatment with a fungicide for clubroot control to a farm field before settled planting seedlings of brassica vegetables. This method is considered to be carried out in order to prevent the root hair from infection (primary infection) with Plasmodiophora brassicae. However, in the conventional way of thinking, a “controlling method in the case where the timing of treatment is missed” is not practically used because of various problems such as necessity of performing the treatment at a high concentration.

Furthermore, the period until infection of Plasmodiophora brassicae into cortex cells (cortex infection) is considered to be about 7 days after the settled planting. As seen from the results of Examples 1 to 3, the controlling methods described in Examples 1 to 3 provide a practical effect at least for 7 days after the settled planting, and the application of cyazofamid using these controlling methods is considered to control the disease even in the stage of primary infection with Plasmodiophora brassicae. That is, a practical effect can be exhibited by the treatment at a practical concentration which does not cause various problems. As described above, according to this treatment method, the timing of application can be extended by at least 7 days after settled planting, and this point is very important in the actual fields.

### Example 4

### Influence of Rainfall on Clubroot Control Effect in Cabbage

In order to demonstrate the remarkable effect of the controlling method of the present invention in the “farm field which is difficult to be subjected to an incorporation treatment with a dust formulation” due to weather or soil conditions, a test was carried out as follows.

The test was carried out by the same method as in Example 3 except for preparing an area subjected to a rainfall treatment of 20 mm by means of a rainfall apparatus (a treatment at a rate of 10 mm/hour for 2 hours) the day before treatment, and an area not subjected to the rainfall treatment. Sixty-seven days after the settled planting, the number of each index of clubroot adhesion to the root was investigated. For comparison, the same test was carried out on a control section where a soil drench treatment with the chemical solution for spraying was not applied.

### Comparative Example 4

The test was carried out by the same method as in Example 4 except that in place of the soil drench treatment with the chemical solution for spraying, 30 kg/10 a of 0.3% flusulfamide (dust formulation of Nebijin [trade name], manufactured by Mitsui Chemicals Agro, Inc.) was applied to the test soil just before the settled planting and incorporated into the soil by means of a small mixer (interfusion depth: 15 cm).

The disease severity and disease control value of Example 4 and Comparative Example 4 were determined by the same methods as in Example 1 and Comparative Example 1. In addition, the weight of cabbage in the aerial part was measured. The test results were shown in Table 4. Furthermore, the test result was shown by the average value of five plantings.

TABLE 4

| | | | | | Weight |
|---|---|---|---|---|---|
| | | | | Disease | in the |
| | | Timing of | Disease | control | aerial |
| | | treatment | severity | value | part (g) |
| Example 4 | Without rainfall | Just after | 0 | 100 | 129 |
| | treatment | settled planting | | | |
| | With rainfall | Just after | 0 | 100 | 121 |
| | treatment | settled planting | | | |
| | | 4 days after | 0 | 100 | 133 |
| | | 7 days after | 5 | 93 | 129 |
| | | 14 days after | 50 | 29 | 103 |
| Compar- | Without rainfall | Just before | 0 | 100 | 118 |
| ative | treatment | settled planting | | | |
| Example 4 | With rainfall | Just before | 35 | 50 | 104 |
| | treatment | settled planting | | | |

| | | | | |
|---|---|---|---|---|
| Control section | — | 70 | 0 | 106 |

As seen from the test results, in Example 4, even when a rainfall treatment was carried out, a practical control effect was obtained by the treatment within 7 days after settled planting, but in Comparative Example 4, when a rainfall treatment was carried out, a practical control effect was not obtained. In addition, in Comparative Example 4, when a rainfall treatment was carried out, the weight (g) in the aerial part was greatly affected by the disease.

These results showed that this controlling method was not affected by rainfall and even in a season or region having a lot of rainfall and the stable control effect could be obtained.

While the invention has been described in detail and with reference to specific embodiments thereof, it will be apparent to one skill in the art that various changes and modifications can be made therein without departing from the sprit and scope thereof.

This application is based on Japanese patent application No.2011-002691 filed on Jan. 11, 2011, the entire contents of which are incorporated hereinto by reference. All references cited herein are incorporated in their entirety.

### INDUSTRIAL APPLICABILITY

The present invention has an industrial applicability as a clubroot control method insusceptible to weather or soil conditions.

Furthermore, cyazofamid is a very useful chemical having a property that “cyazofamid can be applied to brassica vegetables after seeding or settled planting in a farm field”, and also in this point, the present invention has an industrial applicability.

1. A method for controlling clubroot, comprising applying cyazofamid to brassica vegetables after seeding or settled planting in a farm field.

2. The method according to claim 1, wherein cyazofamid is applied by a foliage application or a soil treatment.

3. The method according to claim 1, wherein cyazofamid is applied by a soil treatment.

4. The method according to claim 3, wherein the soil treatment is a soil drench.

5. The method according to claim 3 or 4, wherein the soil treatment comprises spraying cyazofamid to cultivation soil at 0.05 to 50 g/m².

6. The method according to claim 4, which comprises (1) diluting a suspension concentrate of cyazofamid with water to a concentration of 1 to 1,000 ppm and then (2) treating the base of brassica vegetables after seeding or settled plantation by drenching the chemical solution obtained in (1) at 1 to 1,000 ml per plant.

7. The method according to claim 1, wherein cyazofamid is applied to the brassica vegetable within 30 days after seeding or settled planting in the farm field.

8. The method according to claim 1, wherein the brassica vegetable is at least one selected from the group consisting of turnip, Chinese cabbage, cabbage, broccoli, cauliflower, rape, Tenderstem broccoli, rapeseed, Japanese radish, kyona (Brassica campestris L.), komatsuna (Brassica rapa var.), takana (broad leaved mustard), mizuna (Brassica campestris L.), mibuna (Brassica rapa japonica), nozawana (Brassica rapa L.), mizukakena (Brassica campestris L.), kale, qing-geng-cai, small garden radish, Brussels sprout and wasabi.
